(19) United States
(12) Patent Application Publication
(10) Pub. No.: US 2007/0186043 A1
(43) Pub. Date: Aug. 9, 2007

(54) System and method for managing cache access in a distributed system

(76) Inventors: Darel Emmot, Fort Collins, CO (US); Byron Alcom, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/897,607

(22) Filed: Jul. 23, 2004

(51) Int. Cl. G06F 12/00

(52) U.S. Cl. 711/118

(57) ABSTRACT

Embodiments directed to novel systems and method for cache management in a distributed system are described. In one embodiment, a system comprises a plurality of processing nodes, each processing node comprising a functional unit and has a local memory directly coupled therewith. Each processing node, of the plurality of processing nodes, also comprises a cache controller and an associated cache memory. Finally, each processing node of the plurality of processing nodes comprises logic for writing requested data in the associated cache memory if the request for data originated from a functional unit of another node (or for reading requested data from the associated cache memory, if the request for data originated form a functional unit of another node).

### BACKGROUND OF THE INVENTION

1. Field of the Invention

The present invention relates to computer systems and, more particularly, to a novel system and method for managing cache access among processing nodes in a distributed system.

2. Discussion of the Related Art

A wide variety of caching systems are known for a wide variety of computer architectures and environments. As is known, many computing systems use cache memories to improve performance and efficiencies of various components or functional units within a computer system. As is known, a low-level functional unit, having a local cache (sometimes referred to as an L1 cache), typically speeds its operation and efficiency by utilizing the local cache for frequent or recent data transactions. When, however, data written to a local cache is required by a remote functional unit within a computing system, cache management typically copies that data back to a remote cache and/or system memory in order to preserve the data integrity.

This types of cache management technique is known to be inefficient if a significant amount of time is spent flushing data (from one cache) that is requested by other remote processors or functional units.

It is, therefore, desired to provide systems and methods that improve the efficiency of the management of caches in systems having multiple caches.

### SUMMARY

Accordingly, embodiments of the present invention are broadly directed to novel systems and method for cache management in a distributed system. In one embodiment, a system comprises a plurality of processing nodes, each processing node comprising a functional unit and has a local memory directly coupled thereto. Each processing node, of the plurality of processing nodes, also comprises a cache controller and an associated cache memory. Finally, each processing node of the plurality of processing nodes comprises logic for writing requested data in the associated cache memory if the request for data originated from a functional unit of another node (or for reading requested data from the associated cache memory, if the request for data originated from a functional unit of another node).

### DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagram illustrating an embodiment of the present invention implemented in a nodal environment;

FIG. 2 is a diagram illustrating an alternative embodiment of the present invention;

FIG. 3 is a flowchart illustrating a top-level operation of an embodiment of the present invention;

FIG. 4 is a diagram illustrating an alternative embodiment of the present invention; and

FIG. 5 is a flowchart illustrating a top-level operation of an embodiment of the present invention.

### DETAILED DESCRIPTION

Before discussing certain features and aspects of the present invention, it is noted that embodiments of the present invention may reside and operate in a unique nodal architecture in which nodes comprise functional units that intercommunicate across communication links. It will be appreciated, however, that embodiments of the invention may reside and operate other architectures and environments as well, consistent with the scope and spirit of the invention.

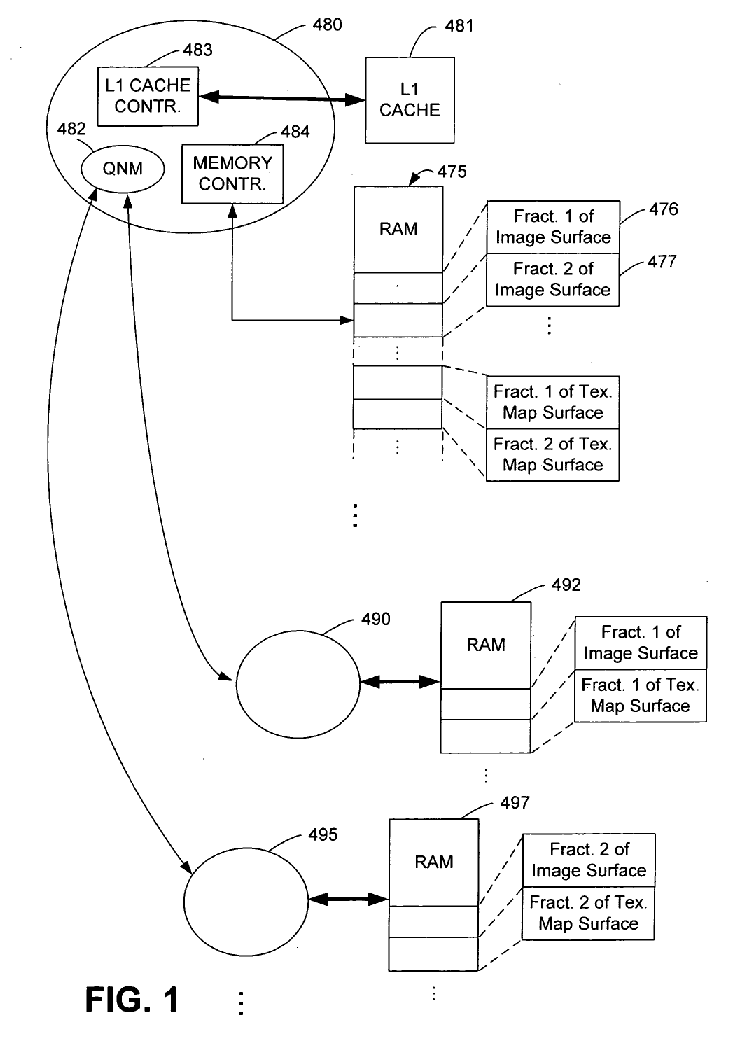

Reference is now made to FIG. 1, which illustrates one embodiment in which certain benefits and advantages of the present invention are realized. The example of FIG. 1 operates in a nodal environment. In this regard, processing nodes 480, 490, 495 (and others not illustrated) may intercommunicate and cooperate to perform various processing functions and tasks. Each processing node (e.g., 480) includes a mechanism or logic for communicating with other processing nodes. In the illustrated embodiment, each processing node (e.g., 480) communicates with other nodes through a QNM (e.g., 482). Further, the functional units with the various nodes may intercommunicate in accordance with a messaging scheme as briefly described herein, and further described in co-pending patent application Ser. No. 10/109,829 (which is incorporated herein by reference).

As further described in co-pending application Ser. No. 09/768,664, filed on Jan. 24, 2001, the contents of which are hereby incorporated by reference, a nodal system, such as the system described herein, may be structured such that non-overlapping portions of the RAMs 475, 492, 497 (and others not shown) may be configured to appear as a unified memory. A portion of this RAM memory 475 may be designated to provide a centralized cache storage for system memory (sometimes referred to as a L2 cache). In accordance with a unified memory architecture, this L2 cache may reside in portions associated with various nodes 480, 490, and 495 of the illustrated embodiment, and an appropriate control mechanism may be provided for managing data accesses to this cache memory. As will be appreciated form the embodiments described herein, various novel features are provided independent of the L2 cache, and embodiments of the invention may be implemented in systems implementing an L2 cache, while other embodiments may be implemented in systems not having an L2 cache.

Each processing node, including node 480, may include a separate cache controller 483 (not shown for the other nodes) that controls and manages L1 cache accesses for transactions that are local to that node. The general concept of L1 and L2 caches, their use, and their control is well known and need not be described herein.

By way of example, there are situations in which a functional unit within processing node 490, for example, may either request data to be read from a RAM coupled to a remote node, and may do so without first attempting to access its local L1 cache. Likewise, there are situations in which a processing node 495 may request data from a remote node 480, and the remote node 480 may first look in its local L1 cache 481 to determine whether it contains the requested data, before otherwise retrieving the data from its memory 475.

In the context of a computer graphics system, such benefits may be realized during the texture mapping or rendering process. For example, in a distributed, nodal system such as that described herein, the rendering of an object or scene may be performed by a plurality of the processing nodes, where different nodes may be configured to render or process different graphic tiles, for example. In this regard, the distributed nodes may each operate on a fraction of an image surface, or fraction of a texture map surface, etc. In addition to needing the data for the portions of the image surface that a given processing node may operate upon, the processing node may also require data for adjacent surface fractions in order to properly handle boundary conditions. Frequently, the data for these adjacent surfaces will be stored in the same cache lines for the L1 cache. Therefore, more efficient operation may be realized by first looking to cache memory for the requested data, before performing a read from system memory.

For example, consider an image to be rendered on a display that has been partitioned into a plurality of partitions, whereby a plurality of processing units are provided to perform rendering operations on the plurality of partitioned areas to achieve improved performance through parallelism. In connection with the diagram of FIG. 1, assume node 490 includes a functional unit to perform certain processing on a first fraction 476 of an image surface, while node 495 contains a functional unit that is configured to perform processing on a second fraction of the image surface 477. As further illustrated, the first and second fractions of the image surface may be stored in RAM 475 that is local to node 480. In addition, the two fraction 476 and 477 of the image surface may reside within the same partition of the image. When, during the context of processing the image, the functional unit within node 490 requests the first fraction 476 of the image surface from node 480, this fraction is retrieved from the RAM 475 by memory controller 484. Assuming that the L1 cache 481 is configured such that both fraction 476 and fraction 477 of the image surface would fit within a single cache line (or grouping of cache lines) than then memory controller 484 would retrieve from memory both fractions 476 and 477 of the image surface and, through the cache controller 483, would store them in the L1 cache 481. The first fraction 476 of the image surface would also be communicated from node 480 to the requesting node 490. It is contemplated that a similar functional unit within node 495 would make a similar request of node 480 to retrieve the second fraction 477 of the image surface. Upon receipt of this request from node 495, node 480 could simply retrieve the requested fraction 477 of the image surface from its L1 cache 481 and return that requested data immediately to node 495, without having to make any additional memory accesses from the memory 475.

It should be appreciated that the foregoing has been only a single illustration, of many possible illustrations and examples, in which data or information that is stored in relative proximity in a system memory may be requested by multiple, remote processing units for various processing or operations thereon. By sizing and configuring the L1 cache 481 appropriately, sufficient chunks of data from within the RAM 475 can be retrieved from the RAM in a single access (or burst access) and stored within the L1 cache for later retrieval by an ensuing request from a remote processing unit. In many embodiments or environments, this approach can significantly improve system performance by reducing the bandwidth requirements of memory. Graphics processing, as mentioned in the example presented above, is one such embodiment in which high bandwidth demands are typically placed on system memory. Therefore, methodologies for conserving memory bandwidth result in significant overall performance gains by the system.

As previously described, the management and handling of data among various nodes may be accomplished through the cooperation among consumer and producer functional units, and the respective work queues. The embodiment of FIG. 1 is presented to illustrate only one possible situation in which benefits of the present invention may be realized. It should be appreciated, however, that the benefits and advantages of the present invention may be realized in a wide variety of applications and architectures. In this regard, the application of the present invention is not limited to a computer graphics system, nor is the architecture limited to the nodal architecture described above.

In short, the embodiment of FIG. 1 is provided to support a methodology in which requests for data or information that is stored local to a particular node (e.g., 480) or processing unit, made by remote nodes (e.g., 490, 495, etc.) or processing units are serviced via a cache memory (e.g., 481) that is associated with the node or processing unit associated with the requested information. In prior art systems, such remote requests were serviced directly by the memory (bypassing any local cache) of the requested node or processing unit. Such prior art systems are predicated on the recognition or assumption that data requested from remote processing units is unlikely to be stored in a cache memory associated with the requested processing unit, and therefore attempts to retrieve data from such a cache memory would typically be futile. Furthermore, in prior art systems, data retrieved from memory (e.g., 475) associated with a given processing unit or node (e.g., 480) would be delivered directly from the node 480 to the requesting node or processing unit, without being written into the cache memory 481 of the requested node. This operation is predicated on the recognition that requests by remote processing units for data would typically not be repeated and would typically result in wasted writes (and subsequent flushes) of data into the cache memory 481.

In addition to the particular embodiment described above, it will be appreciated that alternative embodiments may be implemented consistent with the scope and spirit of the invention. For example, the embodiment described above depicts the determination of the likelihood that a cache line will be reaccessed as the criteria for determining whether the line should be allocated in the local cache. This determination may be made in a variety of ways. Further, other determinations may be implemented consistent with an overarching goal of an embodiment: namely, to reduce the bandwidth consumption of the memory (as opposed to reducing memory latency as in typical cache implementations).

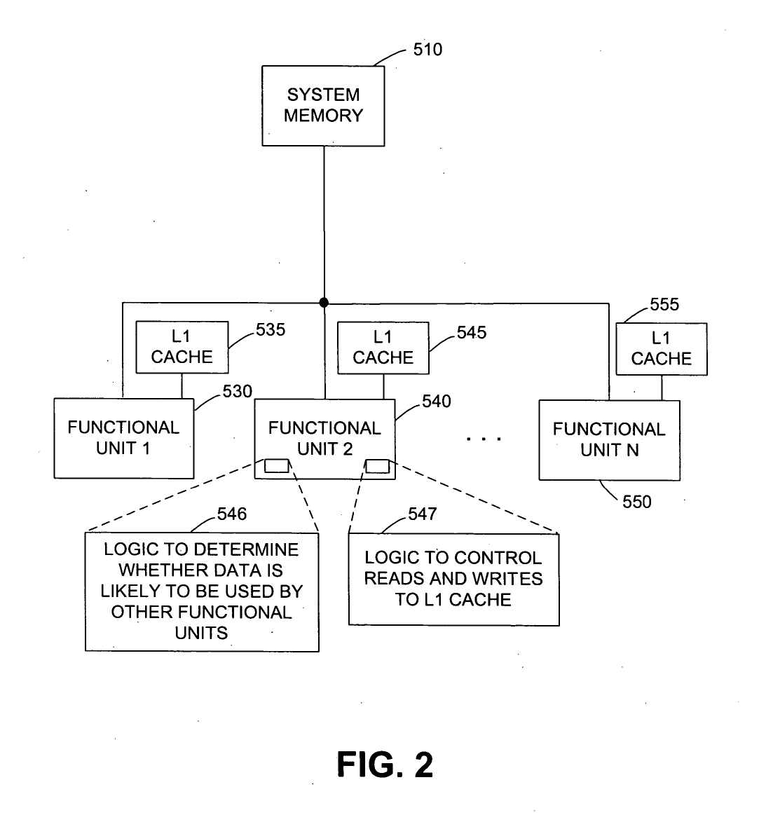

Reference is made to FIG. 2, which illustrates an alternative embodiment of the present invention. In the embodiment of FIG. 2, a system memory 510 may be provided to store data that is used or accessed by a variety of functional units within the system. A plurality of functional units 530, 540, and 550 may also be provided. These functional units may be designed to carry out certain tasks, and may be interconnected to each other and in communication with the system memory 510. Local (or L1) caches 535, 545, and 555 may also be provided to provided local caching for the various functional units. One or more of the functional units may include logic, in accordance with embodiments of the invention, to provide unique management of data to and from the associated L1 cache. In one embodiment, a functional unit 540 may include logic 546 to determine whether data that is being read is to be used by other functional units. If so, then the data may retrieved from the system memory 510 is written into the L1 cache 545. Of course, the logic 546 may take a variety of forms, and more significantly may be configured to operate in accordance with a wide variety of rules or policies. Logic 547 may be provided to cooperate with logic 546 in controlling reads and writes to the L1 cache 545.

The operation of the system illustrated in FIG. 2 is similar to the operation of the system illustrated in FIG. 1. FIG. 2 has been provided to illustrate an architecture in a conventional (non-nodal) architecture. In such a system, functional unit 530 may request data that resides in a memory associated with the second functional unit 540. Upon receiving such a request, the functional unit 540 may first check its L1 cache 545 to determine whether the data resides within the cache. If the data is determined to reside within the cache 545, then the data is retrieved from the cache and delivered to the requesting functional unit 530. If the requested data is not currently within the cache 545, then the functional unit 540 retrieves the data from its associated memory (or a portion of system memory 510 allocated to the functional unit 540). Once the information has been retrieved from system memory 510, it is delivered to functional unit 530. Logic 546 that is configured to determine whether the data is likely to be used by other functional units may be utilized by logic 547 to determine whether the data or information retrieved from the system memory 510 is written into the cache 545.

In one embodiment, if it is determined that the data is likely to be used by other functional units, or if data that is located in proximal memory locations to the requested data (i.e., data read into the same cache line or lines as the requested data), then the requested data will be written into the cache memory 545. It should be appreciated that this determination of whether the data is likely to be requested by other functional units may be based on a variety of factors consistent with the scope and spirit of the embodiments described herein. In one embodiment, the determination may be made based upon the identity of the functional unit requesting the data (e.g., rasterizer, geometry accelerator, shader, etc.). In this regard, the identity of the functional unit requesting the data may provide a good indication as to the processing that is to be performed on the data, and therefore the processing that may be performed in immediate succession on the same or adjacent data. Similarly, the identity of the data itself may be used as an indication as to whether that same data, or data located adjacent to the requested data, is likely to be requested again within a short time period (e.g., before the requested data is flushed from the cache 545). For example, if the identity of the data requested comprises a portion of an image surface, a portion of a texture map, etc., then it may be determined that that requested data (or data located near the requested data) will likely be requested again in a relatively short period of time.

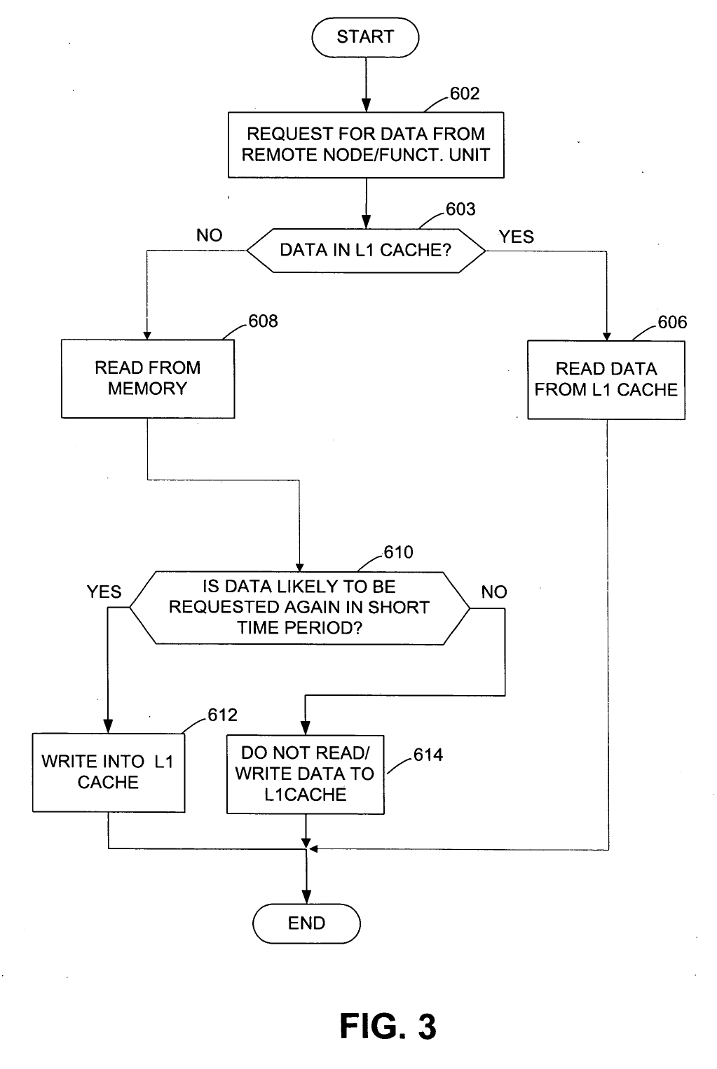

Having illustrated top-level diagrams of two differing embodiments, reference is now made to FIG. 3, which is a flowchart illustrating a top-level operation of an embodiment of the present invention. In the embodiment illustrated in FIG. 3, a request for data from a remote node or functional unit (602) is received. In response to such a request, a determination 603 is made as to whether the requested data resides within the L1 cache that is associated with the requested node or functional unit. If the requested data does, in fact, reside within the L1 cache, then the requested data is read directly from the L1 cache (606). Otherwise, the requested data is read from memory 608 and delivered to the requesting node or functional unit. A determination is made 610 as to whether the data (or data located near the requested data) is likely to be requested again in a relatively short period of time. If so, then the data retrieved from the memory is written into a L1 cache associated with the requested node or functional unit (612). Otherwise, the data read from memory is not written into the cache associated with the requested node or functional unit (614). It should be appreciated that the flowchart of FIG. 3 illustrates merely one embodiment, and that variations and other embodiments, consistent with the scope and spirit of the invention may be provided as well.

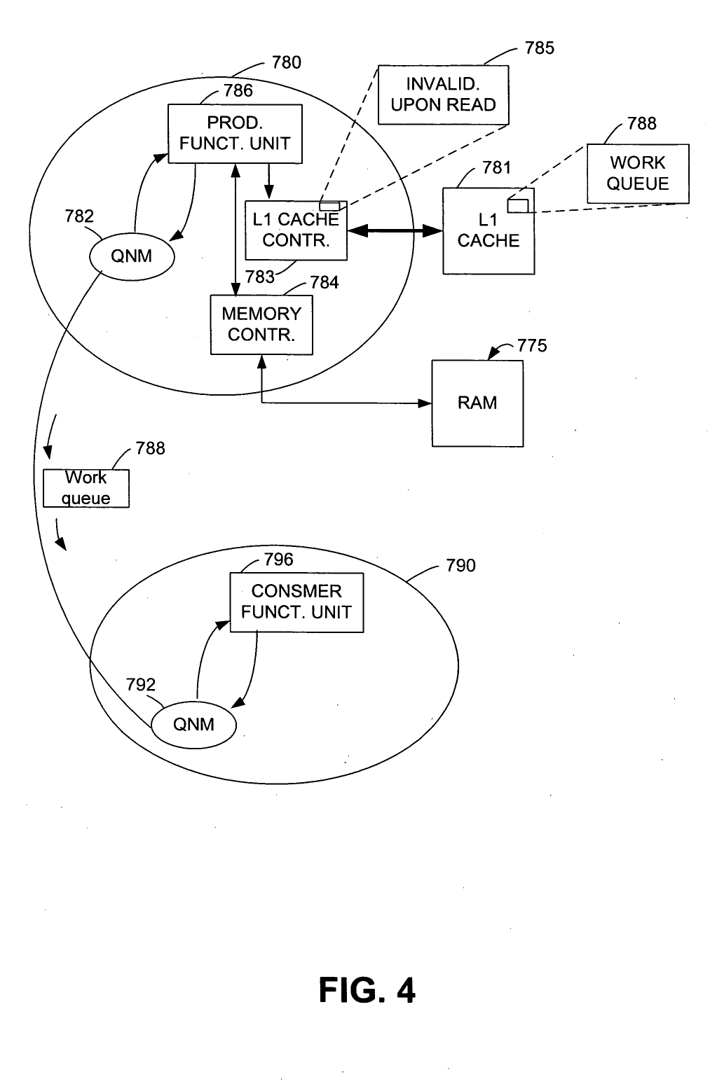

Reference is now made to FIG. 4, which is a diagram similar to the diagram of FIG. 1 but illustrating an alternative embodiment of the present invention. In the copending applications, which have been incorporated by reference herein, the concept of work queues, producer functional units, and consumer functional units have been thoroughly described. In short, a producer functional unit operates to produce instructions and/or information in a work queue that may be retrieved (or consumed) by a consumer functional unit. The embodiment illustrated in FIG. 4, may make specialized use of a cache memory 781 to realize certain performance and efficiency enhancements, with respect to memory bandwidth utilization. In this regard, a node or processing unit that contains or embodies a producer or functional unit 786 may generate a work queue as described in the copending patent applications. However, rather than writing the produced work queue into the memory 775 that is associated with the node 786, the work queue is, instead, produced directly into the L1 cache 781 that is associated with the node 780. Thereafter, when a consumer functional unit 796 requests or retrieves to the work queue 788 for operating thereon, the work queue 788 is retrieved directly from the L1 cache 781. Since the work queue 788 was never written into the local memory 775 of node 780, no right back or synchronization need be performed between the cache 781 and memory 775. Instead, the segment of the cache 781 containing the work queue 788 may simply be invalidated (or designated as invalid or dirty) and additional memory cycles to write data to the RAM 775 need not be expended. This operation is based upon the recognition that once the work queue has been retrieved by the appropriate consumer functional unit 796, no other request will ever be made node 780 for the work queue 788.

Having described the top-level operation of this embodiment, FIG. 4 illustrates a first node 780 containing a producer functional unit 786, a local memory 775, and a local cache memory 781. An appropriate cache controller 783 and memory controller 784 are also provided to manage data reads and writes to the cache 781 and memory 775, respectively. A QNM 782 (as fully described in copending applications) is provided to manage data transactions or transfers over communication links between node 780 and 790. Local memories and cache memories like 775 and 781 may also be provided in connection with node 790, but have not been illustrated herein. Logic (not specifically shown) within the producer functional unit 786 may control the production of a work queue 788 directly into the cache 781. Upon retrieval of the work queue 788 (in response to a request from a remote consumer functional unit), logic 785 within the cache controller 783 may be provided to invalidate the portion of the cache 781 that stored the work queue 788.

In the event such data written directly into the cache 781 is later evicted (e.g., flushed from the cache due to the cache filling up with other data) before being read, then the data is written into the RAM 775, as is typical behavior for evicted modified data in a cache. Thereafter, if the data is read by a remote consumer functional unit, it will be retrieved directly from the RAM 775 (rather than being read through the cache 781). Further, upon such a read, the data will not be written back into the cache, as it will be determined not to be needed further. The work queue mechanism 788 provides an interface that it written to and read by the functional units. Further, the QNM 792 maintains pointers into the RAM 775, which pointers determine which RAM locations have valid data, whether those RAM locations are resident in the cache or are only in the physical RAM 781.

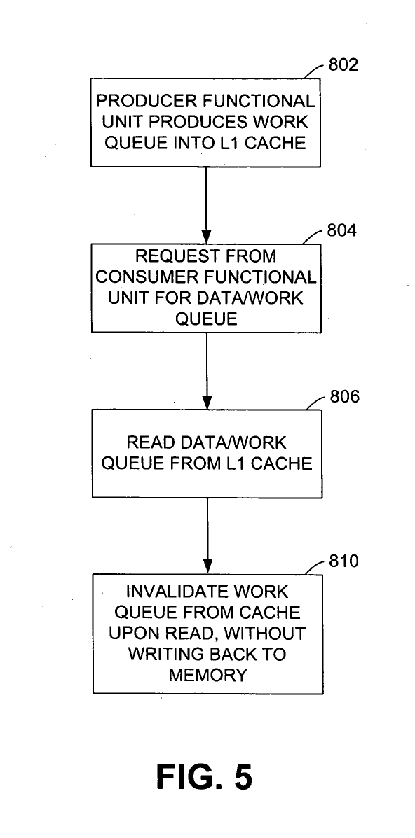

Since the performance and operation of producer functional units, consumer functional units, and work queues have been fully described in the copending applications that have been incorporated herein by reference, no further discussion on these elements is required. Instead, reference is made to FIG. 5 which is a flowchart illustrating the top-level operation of a system like that illustrated in FIG. 4, in accordance with an embodiment of the invention. In a first operation 802, a producer functional unit generates, or produces, a work queue directly into a cache associated with our coupled to the producer functional unit (802). Thereafter, a request from a remote consumer functional unit is made for the data or information contained within the work queue that was produced and written into the cache (804). The data or information comprising the work queue is then read from the L1 cache (806) and delivered to the requesting consumer functional unit. Thereafter, the segment or portion within the cache that comprised the work queue is then invalidated, without writing the data back (or synchronizing the data with) a local or system memory (810). It should be appreciated that the operations described in the embodiments of FIGS. 4 and 5 significantly improve the memory bandwidth demands by permitting producer functional units to produce work queues directly into cash memory and have those work queues retrieved directly from cache memory without ever requiring reads or writes to local RAM or system memory.

What is claimed is:

1. A system comprising:
a plurality of processing nodes, each processing node comprising a functional unit and having a local memory directly coupled therewith;
each processing node of the plurality of processing nodes further comprising a cache controller and an associated cache memory;
each processing node of the plurality of processing nodes further comprising logic for writing requested data in the associated cache memory if data stored near the requested data is likely to be requested again in a proximal time and for bypassing the associated cache memory if the requested data, or data stored near the requested data, is not likely to be requested again in a proximal time.

2. The system of claim 1, further including logic for determining whether data stored near the requested data is likely to be requested again in a proximal time, wherein the data is determined to be near the requested data when the data is contained within a space of a cache storage unit to be written into the cache.

3. The system of claim 2, wherein the cache storage unit is a single cache line.

4. The system of claim 2, wherein the cache storage unit is a plurality of cache lines that are written or read as a group.

5. The system of claim 1, wherein the system is a part of a computer graphics system.

6. The system of claim 1, wherein each processing node of the plurality of processing nodes further comprises logic for determining whether data requested by a remote functional unit, or data adjacent to the data requested, is likely be to requested again in a proximal time.

7. A system comprising:
a plurality of processing nodes, each processing node comprising a functional unit and having a local memory directly coupled therewith;
each processing node of the plurality of processing nodes further comprising a cache controller and an associated cache memory;
each processing node of the plurality of processing nodes further comprising logic for writing requested data in the associated cache memory if the request for data originated from a functional unit of another node.

8. A processing node for a system comprising:
a functional unit capable of producing a work queue;
logic configured to store a work queue produced by the functional unit in a cache memory associated with the node;
logic configured to invalidate data comprising a work queue previously stored in the associated cache memory in response to the data being read from the cache memory in response to a request from a second processing node.

9. The system of claim 8, wherein the second processing node is a consumer node.

10. The system of claim 8, wherein the work queue is stored only in the associated cache memory, and is not stored to system memory.

11. A method comprising:
receiving at a local processing unit a request for data from a remote processing unit;
determining whether the requested data resides within a cache memory associated with a cache memory associated with the local processing unit; and
reading the requested data from the cache memory and communicating it to the remote processing unit, if the requested data is determined to reside in the cache memory.

12. A method comprising:
receiving at a local processing unit a request for data from a remote processing unit;
retrieving the requested data from a system memory;
determining whether the requested data is likely to be requested again in a short time period; and
writing the requested data into a cache memory associated with the local processing unit, if it is determined that the requested data is likely to be requested again in a relatively short time period.

13. The method of claim 12, wherein the determining whether the requested data is likely to be requested again in a short time period is based in part on an identity of the remote processing unit.

14. The method of claim 12, wherein the determining whether the requested data is likely to be requested again in a short time period is based in part on an identity of the data being requested.

15. A method comprising:
generating a work queue by a producer unit;
storing the work queue in a cache memory associated with the producer functional unit;
receiving a request or information of the work queue by a consumer functional unit;
retrieving the requested information from the cache memory and communicating the retrieved information to the consumer functional unit; and
invalidating the retrieved information within the cache memory without writing or synchronizing the retrieved information with a system memory.

16. The method of claim 12, wherein the generating and storing are performed without additionally or separately storing the generated work queue to a system memory.
